(19) United States
(12) Patent Application Publication
(10) Pub. No.: US 2011/0298194 A1
(43) Pub. Date: Dec. 8, 2011

(54) Road Skeez

(76) Inventor: Richard R. Sanchez, Irving, TX (US)

(21) Appl. No.: 12/792,540

(22) Filed: Jun. 2, 2010

(51) Int. Cl. A63C 17/12; B62M 1/16; A63C 17/04

(52) U.S. Cl. 280/245; 280/281.1; 280/242.1

(57) ABSTRACT

A transport device for transporting a user may include a first riding platform to support a user and to propel the user, a second riding platform being opposed to the first riding platform to support the user and to propel the user, and a leading traverse frame member to connect the first platform with the second platform. The leading traverse frame member may allow the first rider platform to move radially and to move axially with respect to the second rider platform. The first riding platform may be connected to the second riding platform with a trailing frame member, and the trailing frame member may allow the first platform to move axially and move radially with respect to the second riding platform. The leading frame member may include a ball clevis, and the trailing frame member may include a ball clevis. The transport device may include a handle to propel the transport device, and the handle may be connected to a rack and pinion device.

### FIELD OF THE INVENTION

The present invention relates to transport devices and more particularly to a combination skateboard and ski board.

### BACKGROUND

Skateboarding is a popular sport especially among young people. The typical skateboard may include a platform for the user to stand and a set of wheels which may be attached to the underside of the skateboard. The skateboard may have rounded corners in order to eliminate some injuries. The users of the skateboards may simply propel themselves, or skateboarders typically like to do tricks and jumps using their skateboards.

Downhill skiing is a popular sport in which there have been a number of important developments bringing greater excitement, fun, and safety. Snowboarding has brought increased excitement to downhill skiing, but has generally been limited to those with greater athletic ability and flexibility. Safety can be easily compromised.

### SUMMARY

A transport device for transporting a user may include a first riding platform to support a user and to propel the user, a second riding platform being opposed to the first riding platform to support the user and to propel the user, and a leading traverse frame member to connect the first platform with the second platform.

The leading traverse frame member may allow the first rider platform to move radially and to move axially with respect to the second rider platform.

The first riding platform may be connected to the second riding platform with a trailing frame member, and the trailing frame member may allow the first platform to move axially and move radially with respect to the second riding platform.

The leading frame member may include a ball clevis, and the trailing frame member may include a ball clevis.

The transport device may include a handle to propel the transport device, and the handle may be connected to a rack and pinion device.

The rack and pinion device may be a unidirectional rack and pinion device, and the unidirectional rack and pinion device may include a unidirectional gear bearing.

The rack and pinion device may be connected to a ball clevis to connect to the handle, and the transport device may include a front wheel and a rear wheel which may be connected to a shock absorber.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the transport device of the present invention;

FIG. 2 illustrates a bottom view of the transport device of the present invention;

FIG. 3 illustrates a side view of the transport device in a first position of the present invention;

FIG. 4 illustrates a sectional view of the transport device of the present invention;

FIG. 5 illustrates a sectional view of the transport device of the present invention;

FIG. 6 illustrates a sectional view of the transport device of the present invention;

FIG. 7 illustrates a sectional view of the transport device of the present invention;

FIG. 8 illustrates an embodiment of the transport device of the present invention;

FIG. 9 illustrates a side view of the transport device in a second position.

### DETAILED DESCRIPTION

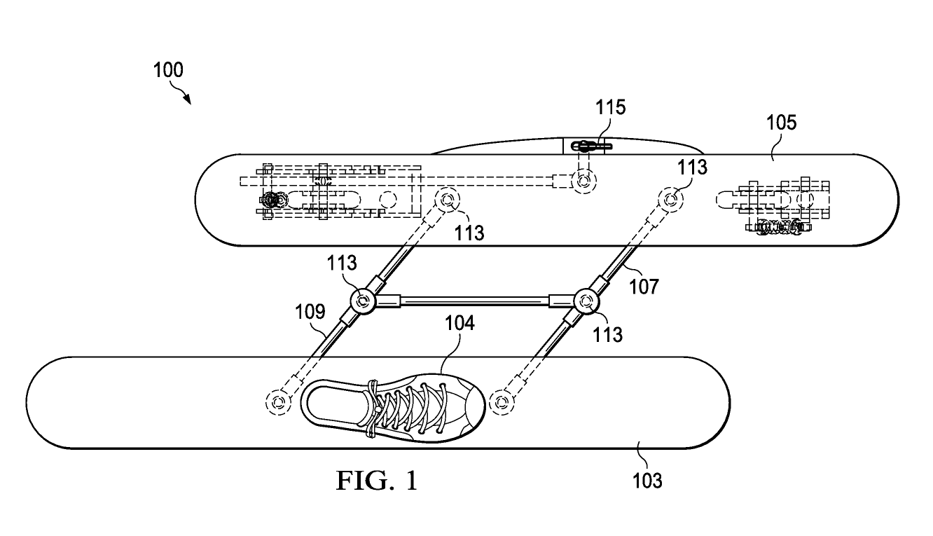

FIG. 1 illustrates a top view of the Road Skeez or transport device 100 of the present invention and illustrates a first riding platform 103 for providing a movable platform for the user as represented by the shoe 104 of the user and a second riding platform 105 which may be connected but opposed to the first riding platform 103. The first riding platform 103 may be connected to the second riding platform 105 by a leading traverse frame member 107 which may be a rod, bar or other type of supporting frame and by a trailing traverse frame member 109 which may be a rod, bar, or other type of supporting frame. The leading traverse frame member 107 may be pivotably connected to the first riding platform 103 and the second riding platform 105 by a fastening device 113 which may allow the frame member 107, 109 to pivot by moving axially and radially by rotating around a axle of the fastening device 113 and also may allow limited movement in the axial direction of the frame member 107, 109. The fastening device 113 may be a ball clevis and may be used to pivotably connected other members of the present invention as described herein below.

FIG. 1 additionally illustrates a connecting longitudinal frame member 111 which may connect the leading traverse frame member 107 to the trailing traverse frame member 109 by a fastening device 113. FIG. 1 illustrates a handle 115 to carry the transport device 100.

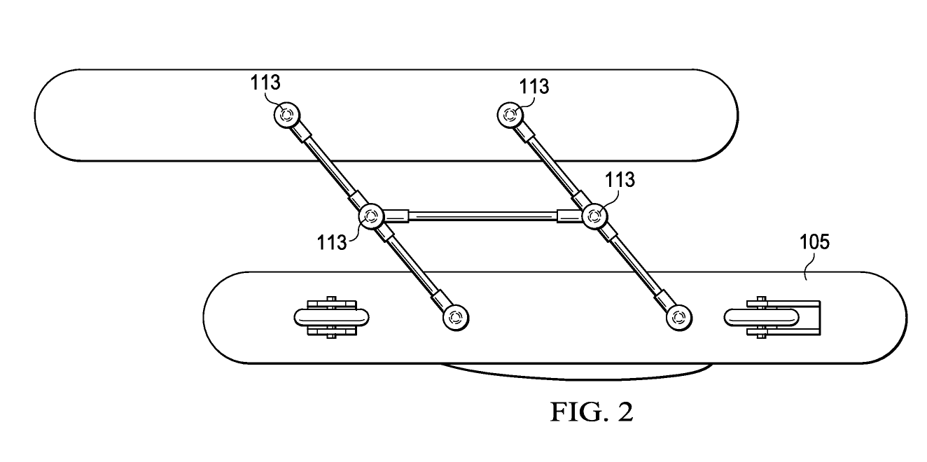

FIG. 2 illustrates a bottom view of the Road Skeez or transport device 100 of the present invention and illustrates a first riding platform 103 for providing a movable platform for the user as represented by the shoe 104 of the user and a second riding platform 105 which may be connected but opposed to the first riding platform 103. The first riding platform 103 may be connected to the second riding platform 105 by a leading traverse frame member 107 which may be a rod, bar or other type of supporting frame and by a trailing traverse frame member 109 which may be a rod, bar, or other type of supporting frame. The leading traverse frame member 107 may be pivotably connected to the first riding platform 103 and the second riding platform 105 by a fastening device 113 which may allow the frame member 107, 109 to pivot by rotating around a axle of the fastening device 113 and also may allow limited movement in the axial direction of the frame member 107, 109. The fastening device 113 may be used to pivotably connected other members of the present invention as described herein below.

FIG. 2 additionally illustrates a connecting longitudinal frame member 111 which may connect the leading traverse frame member 107 to the trailing traverse frame member 109.

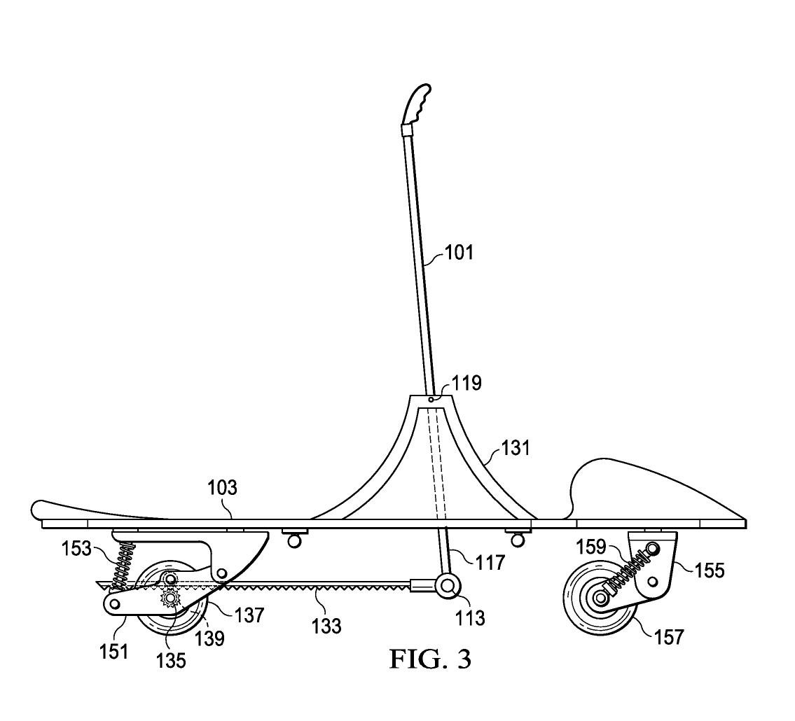

FIG. 3 illustrates a side view of the transport device 100 in a first position and illustrates the first riding platform 103 (alternatively, the teachings of FIG. 3 could be applied to the second riding platform 105). FIG. 3 additionally illustrates a pivot frame member 131 to provide a pivot point 119 to cooperate with the handle 101 which may extend below and above the riding platform 103, 105 and may be used to propel the transport device 100 under conditions when there is insufficient gravity to propel the transport device 100. The handle 101 may be connected to a unidirectional rack and pinion 133 by a fastening device 113 to provide a pivotable connection to the rack and pinion 113. The handle 101 drives the rack and pinion 113 as the handle 101 is pushed/pull forward by the user and the lower portion of the handle 101 cooperates by pushing the rack and pinion 113 rear wards rotating the unidirectional gear bearing 139 and the axle 135 of the rear wheel 137 and consequently rotating the rear wheel 137. As the handle 100 is returned to the original position, the rack and pinion 133 does not engage the unidirectional gear bearing 139. FIG. 3 additionally illustrates a wheel frame member 151 which may be substantially U-shaped in order to cooperate with the wheel 137. The wheel frame member 151 may be connected to a shock absorber member 153 which may be connected to the bottom surface of the riding platform 103, 105. FIG. 3 additionally illustrates a pivoting castor 155 which may be pivotably connected to the bottom surface of the riding platform 103, 105 and may include a biasing device such as the spring to urge the pivoting castor 155 to return to the original position. The pivoting castor 155 may be rotatably connected to the front wheel 157, and the pivoting castor 155 may be connected to a shock absorbing member 159.

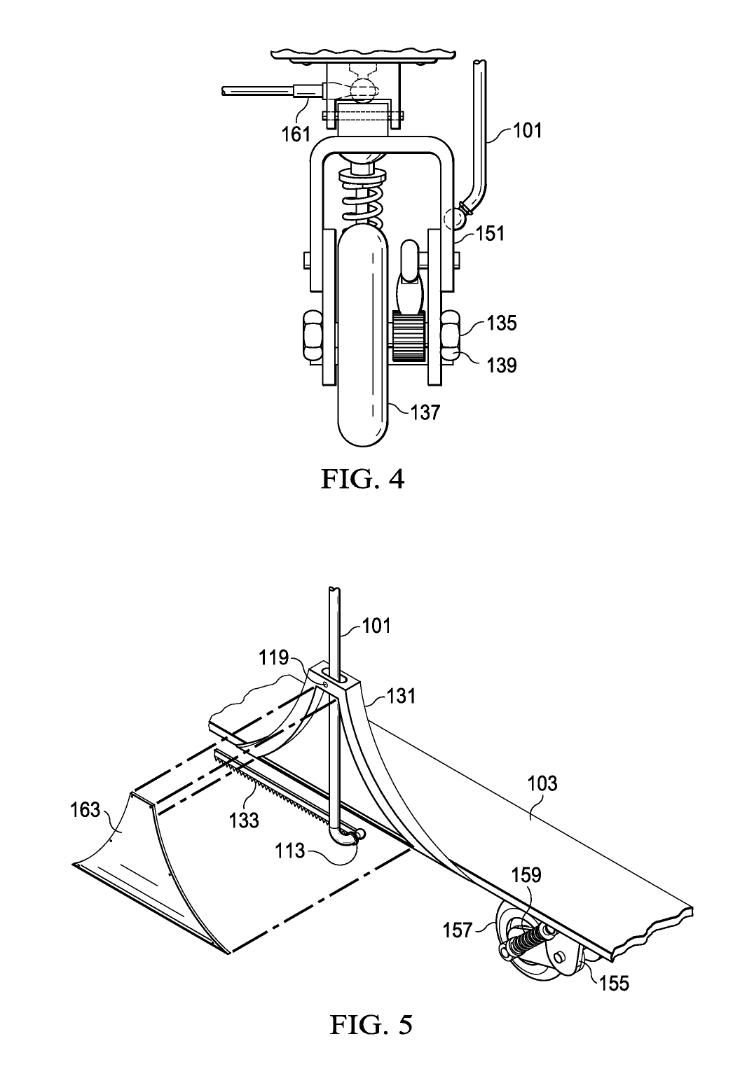

FIG. 4 illustrates a portion of the transport device 100 and illustrates the wheel frame 151, which may be connected to the unidirectional gear bearing 139, the axle 135, the wheel 137, the handle 101 and illustrates a ball and socket joint 161.

FIG. 5 illustrates a pivot frame member 131 to provide a pivot point 119 to cooperate with the handle 101 which may extend below and above the riding platform 103, 105 and may be used to propel the transport device 100 under conditions when there is insufficient gravity to propel the transport device 100. The handle 101 may be connected to a unidirectional rack and pinion 133 by a fastening device 113 to provide a pivotable connection to the rack and pinion 113. The handle 101 drives the rack and pinion 113 as the handle 101 is pushed/pull forward by the user and the lower portion of the handle 101 cooperates by pushing the rack and pinion 113 rear wards rotating the unidirectional gear bearing 139 and the axle 135 of the rear wheel 137 and consequently rotating the rear wheel 137. FIG. 5 additionally illustrates the front wheel 157, the shock absorbing member 159 and the pivoting castor 155. A fairing cover 163 may be attached to the pivot frame member to define a fairing.

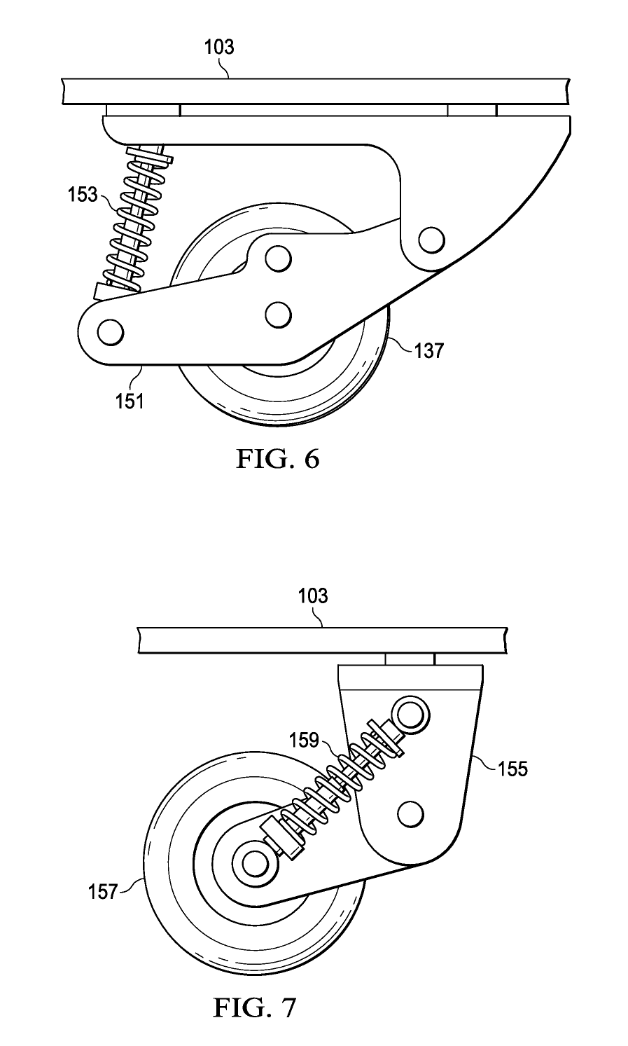

FIG. 6 additionally illustrates a wheel frame member 151 which may be substantially U-shaped in order to cooperate with the wheel 137. The wheel frame member 151 may be connected to a shock absorber member 153 which may be connected to the bottom surface of the riding platform 103, 105.

FIG. 7 additionally illustrates a pivoting castor 155 which may be pivotably connected to the bottom surface of the riding platform 103, 105 and may include a biasing device such as the spring to urge the pivoting castor 155 to return to the original position. The pivoting castor 155 may be rotatably connected to the front wheel 157, and the pivoting castor 155 may be connected to a shock absorbing member 159.

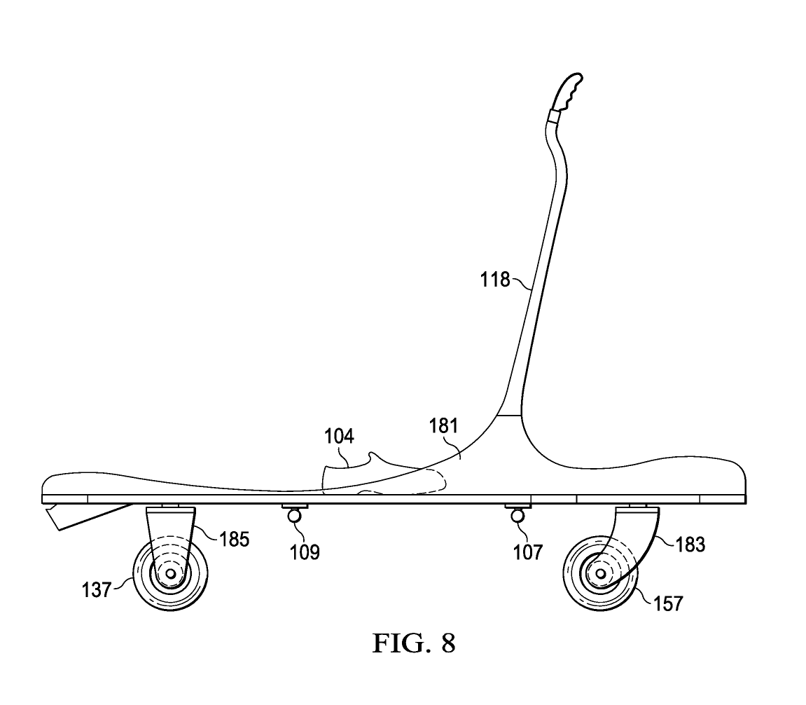

FIG. 8 illustrates a transport device 100 which may include a handle 118 which may be connected to a fairing 181 which may be integral with a first riding platform 104 which may be connected to the second riding platform (not shown) by the leading traverse frame member 107 and the trailing traverse frame member 109 as described herein above. FIG. 8 additionally illustrates a front wheel frame 183 which may be connected to the bottom surface of the first riding platform 103 and connected to the front wheel 157 and a rear wheel frame 185 which may be connected to the bottom surface of the first riding platform 103 and connected to the rear wheel 137.

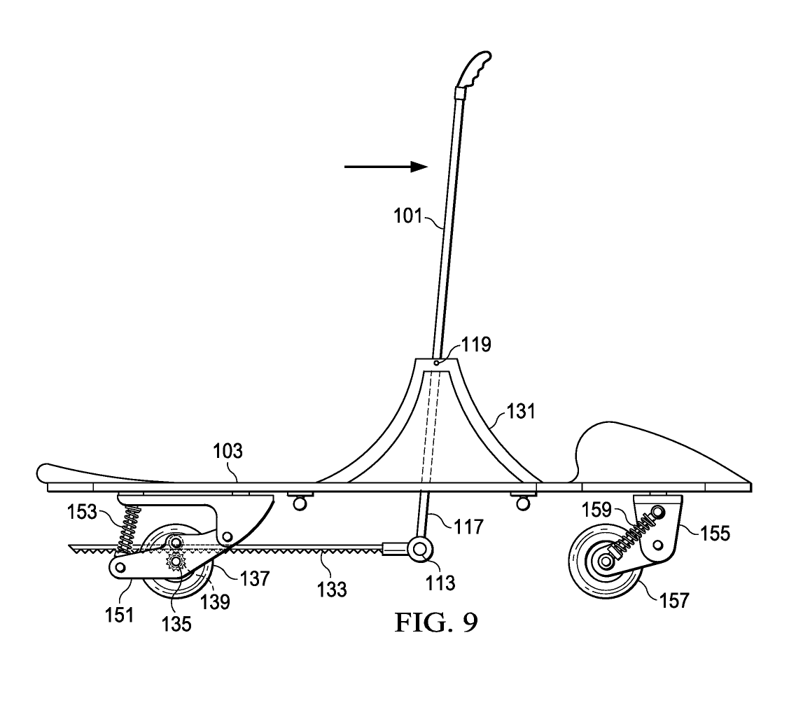

FIG. 9 illustrates a side view of the transport device 100 in a second position and illustrates the first riding platform 103. FIG. 9 additionally illustrates a pivot frame member 131 to provide a pivot point 119 to cooperate with the handle 101 which may extend below and above the riding platform 103, 105 and may be used to propel the transport device 100 under conditions when there is insufficient gravity to propel the transport device 100. The handle 101 may be connected to a unidirectional rack and pinion 133 by a fastening device 113 to provide a pivotable connection to the rack and pinion 113. The handle 101 drives the rack and pinion 113 as the handle 101 is pushed/pull forward by the user and the lower portion of the handle 101 cooperates by pushing the rack and pinion 113 rear wards rotating the unidirectional gear bearing 139 and the axle 135 of the rear wheel 137 and consequently rotating the rear wheel 137. As the handle 100 is returned to the original position, the rack and pinion 133 does not engage the unidirectional gear bearing 139. FIG. 3 additionally illustrates a wheel frame member 151 which may be substantially U-shaped in order to cooperate with the wheel 137. The wheel frame member 151 may be connected to a shock absorber member 153 which may be connected to the bottom surface of the riding platform 103, 105. FIG. 3 additionally illustrates a pivoting castor 155 which may be pivotably connected to the bottom surface of the riding platform 103, 105 and may include a biasing device such as the spring to urge the pivoting castor 155 to return to the original position. The pivoting castor 155 may be rotatably connected to the front wheel 157, and the pivoting castor 155 may be connected to a shock absorbing member 159.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A transport device for transporting a user, comprising:
a first riding platform to support a user and to propel the user;
a second riding platform being opposed to the first riding platform to support the user and to propel the user;
a leading traverse frame member to connect the first platform with the second platform;
wherein the leading traverse frame member allows the first rider platform to move radially and to move axially with respect to the second rider platform.

2) A transport device for transporting a user as in claim 1, wherein the first riding platform is connected to the second riding platform with a trailing frame member.

3) A transport device for transporting a user as in claim 2, wherein the trailing frame member allows the first platform to move axially and move radially with respect to the second riding platform.

4) A transport device for transporting a user as in claim 1, wherein the leading frame member includes a ball clevis.

5) A transport device for transporting a user as in claim 3, wherein the trailing frame member includes a ball clevis.

6) A transport device for transporting a user as in claim 1, wherein the transportation device includes a handle to propel the transport device.

7) A transport device for transporting a user as in claim 6, wherein the handle is connected to a rack and pinion device.

8) A transport device for transporting a user as in claim 7, wherein the rack and pinion device is in a unidirectional rack and pinion device.

9) A transport device for transporting a user as in claim 8, wherein the unidirectional rack and pinion device includes a unidirectional gear bearing.

10) A transport device for transporting a user as in claim 9, wherein the rack and pinion device is connected to a ball clevis to connect to the handle.

11) A transport device for transporting a user as in claim 1, wherein the transport device includes a front wheel.

12) A transport device for transporting a user as in claim 11, wherein the front wheel is connected to a shock absorber.

13) A transport device for transporting a user as in claim 1, wherein the transport device includes a rear wheel.

14) A transport device for transporting a user as in claim 13, wherein the rear wheel is connected to a shock absorber.
